(19) United States
(12) Patent Application Publication
(10) Pub. No.: US 2016/0131533 A1
(43) Pub. Date: May 12, 2016

(54) WINE THERMOMETER

(71) Applicant: Starspot Limited, Daventry Northamptonshire (GB)

(72) Inventors: Steven Parker, New Malden, Surrey (GB); Simon Parslow, Gayton, Northampton (GB)

(73) Assignee: Starspot Limited, Daventry, Northamptonshire (GB)

(21) Appl. No.: 14/896,138

(22) PCT Filed: Jun. 6, 2014
(86) PCT No.: PCT/GB2014/051748

§ 371 Date: Dec. 4, 2015

(30) Foreign Application Priority Data
Jun. 6, 2013 (GB) 1310118.3

(51) Int. Cl. G01K 1/14; G01K 1/02

(52) U.S. Cl. CPC G01K 1/14; G01K 1/02

(57) ABSTRACT

A wine thermometer is described. The wine thermometer is a device for measuring the temperature of a wine bottle comprising a wireless temperature sensing device and a display device. The wireless temperature sensing device comprises a resilient band which is sized and shaped to connect to a wine bottle, one or more temperature sensors and a wireless transmitter. The display device comprises a display and a wireless receiver. The display device is separate from and in wireless communication with the wireless temperature sensing device. The display device is arranged to receive temperature data from the temperature sensor and to indicate the temperature of the wine bottle as measured by the one or more temperature sensors. The wireless temperature sensing device may be located in a fridge, and be adapted for fridge use.

### BACKGROUND

The temperature a wine is served at can have a significant affect on the flavour of the wine. In many cases, wine is served at an incorrect temperature, for example red wines are often served at too high a temperature and white wines are often served at too cold a temperature, which can impair the flavour of the wine. The ideal serving temperature can depend on a number of factors including, for example, the style of wine, the grape variety and the region of origin, personal preferences and type of food being served. Most wines need to be cooled before serving. Wine thermometers, which are typically inserted into or placed onto a wine bottle, can be used to determine whether the wine is at a correct temperature for serving.

### SUMMARY

According to a first aspect of the invention there is provided a device for measuring the temperature of a wine bottle comprising, a wireless temperature sensing device comprising a resilient band and one or more temperature sensors and a wireless transmitter, and a display device comprising a display and a wireless receiver, wherein the display device is separate from and in wireless communication with the wireless temperature sensor, and the display device is arranged to indicate the temperature of the wine bottle as measured by the one or more temperature sensors. In an example a user may place wireless temperature sensing device around a bottle of wine which is placed in a first location, for example, a refrigerator. The user may then place the display device in a different location somewhere that is easily visible. The user may then be able to see at a glance whether the wine bottle to which the wireless temperature sensing device has been attached and therefore the wine within the bottle, is at a correct temperature for drinking without having to check the bottle itself or having to open the bottle in advance to place a thermometer within the bottle of wine, or having to continuously open the fridge to monitor the wine bottle temperature which in turn will raise the ambient temp of the fridge and extend the chilling time.

The invention also relates to a device for measuring a temperature of a wine bottle comprising a wireless temperature sensing device (100, 200, 300) comprising a resilient band (104, 204, 302) and one or more temperature sensors (106, 206, 304) and a wireless transmitter (306); wherein the wireless temperature sensing device is suitable for use with a display device, the display device (102, 202) comprising a display and a wireless receiver; wherein the display device (102, 202) is separate from and may be in, or is in, wireless communication with the wireless temperature sensor; and the display device (102, 202) is arranged to indicate the temperature of the wine bottle as measured by the one or more temperature sensors when the display device is in wireless communication with the sensor.

In one aspect the wireless temperature sensing device and the display device are able to communicate when the former is inside a refrigerator and the latter is outside the refrigerator.

The device may further comprise one or more predefined temperature ranges which are selectable by a user, either on the wireless temperature sensing device and/or the display device. The display device may be provided with at least one further temperature indicator arranged to indicate when the measured temperature of the wine bottle is within the predefined temperature range.

The wireless temperature sensing device may simply be configured to transmit information to a display device, and the display device may be configured to carry out, and may carry out, any necessary computation or comparison to assess whether the bottle is at the desired temperature. Alternatively the wireless temperature sensing device may be configured to carry out, and may carry out, both the sensing and any necessary calculation or comparison, and simply transmit the output to the display device.

The wireless temperature sensing device may also comprise a display which can indicate whether a bottle is at the desired temperature, in addition to the display on the display device. This can help a user by indicating the temperature of a bottle when removed from the fridge, for example, but when the bottle is in a different location to the display.

The one or more predefined temperature ranges may be defined in relation to at least one of; wine type, grape variety, ambient temperature, food type.

The display device may issue an alert when a temperature is below a desired temperature or temperature range, and/or or when the temperature approaches the desired temperature or temperature range, and/or when the temperature is at a predefined temperature or within a predefined temperature range. The alert may be a visual or by audible signal or by vibration or any combination of these. In one aspect the temperature of the wine bottle is indicated by a colour rather than, or in addition to, a numerical readout of temperature. The colour may reflect an appropriate temperature for the wine—it may be red when the wine bottle is too warm or blue when too cold, and green for a preferred temperature or range, for example.

The resilient band may be sized and shaped to connect to a wine bottle, e.g. a standard 750 ml bottle 7-9 cm in diameter, or standard half bottle.

The display device may be a dedicated display device. The display device may be a mobile computing device. In one aspect the mobile computing device may be a mobile telephone.

In one aspect the display device will notify a user when the temperature of the bottle has reached a desired temperature or temperature within a predefined range even when the display device is running another application. For example, the display device may be a mobile telephone and the user may be making a phone call, but the display device will still issue a temperature notification.

The user may be able to manually specify a temperature range or adjust a predefined temperature range.

The display device or wireless temperature sensing device may comprise one or more controls to enable the user to select a temperature range or adjust a predefined temperature range.

The at least one further indicator may be a text indicator. The at least one further indicator may be a colour of the display. The colour of the display may be altered using a plurality of coloured backlights. The display may be arranged to flash to alert the user.

The wireless temperature sensing device and the display device may communicate via Wi-Fi. The wireless temperature sensing device and the display device may communicate via Bluetooth. The wireless temperature sensing device and the display device may communicate via radio frequency.

The resilient band may further comprise a switch arranged to switch the wireless temperature sensing device on when connected to a wine bottle.

The one or more preset temperature ranges may be selected from; sparkling white wine, light bodied white wine and rose wine (6-8° C.), dessert wine (7-10° C.), vintage sparkling wine (8-10° C.), medium white wine (9-11° C.), light bodied red wine (10-12° C.), full bodied white wine (10-13° C.), medium bodied red wine (14-16° C.) and full bodied red wine (16-18° C.).

Where temperatures are stated are in centigrade herein, it will be appreciated that their equivalent Fahrenheit values may also be used in place of, or in addition to Centigrade values. For user convenience these equivalent may be rounded up or down appropriately in any conversion.

Pre-set temperature ranges may also be grape specific. For a given grape, or a wine type (such as dessert wine or sparkling white wine), the display may show a different colour or other indication for e.g. the preferred temperature range, a temperature below the range and a temperature above the range.

In one aspect temperature ranges are pre-programmed into the device. In one aspect pre-set temperature ranges may be modified by a user, or may be created by a user. For example, a user may modify the temperature range when the ambient temperature is especially hot or cold, or within abnormal conditions such as in flight where tasting senses are altered.

The device may further comprise a barcode reader.

The wireless temperature sensing device is suitably compatible for use in a refrigerator (e.g. from 1.5-10 degrees Celsius), preferably for a period of at least an hour or more, such as 1, 2, 3, 4, 5 hours, and preferably is able to be used both in and out of the fridge.

In one aspect the sensing device may comprise a magnet to be attached to a fridge when not in use within a fridge.

The wireless temperature sensing device may be adapted to improve accuracy in a low temperature environment, preferably to detect at an accuracy of within 2 degrees C. of bottle temperature within 5 minutes. The sensing device may comprise a heat transfer pad from bottle to sensor/sensor plate and/or an insulating material (including but not limited to neoprene) to insulate a portion of the bottle in contact with the sensing device from the surrounding air.

The wireless temperature sensing device may be primarily made of a plastics material. For example the resilient band may comprise or consist of a plastics material. In one aspect all of the wireless temperature sensing device is plastic except the sensor.

In one aspect the present invention relates to any device as disclosed herein comprising one or more of

(i) an alert or signal to a user to remove a bottle of wine from a fridge before it becomes too cold or to replace it in the fridge when too warm; and/or

(ii) the device uses a colour display to indicate the temperature of a bottle in comparison with a pre-set temperature or temperature range preference and/or

(iii) the temperature preference (either as a single temperature or range) may be pre-set or programmable by a user; and/or

(iv) the sensing device inside a closed fridge is suitable for communication with a sensing device located outside a closed fridge;

and suitably any combination of the above, such as all of the above, or such as a combination of (i) and (ii); (i) and (iii), or (i) and (iv); or (ii) and (iii), or (ii) and (iv), or (iii) and (iv), or (i) (ii) and (iii), or (ii), (iii) and (iv), or (i) (ii) and (iv) or (i) (iii) and (iv).

In a further aspect the invention relates to any device as disclosed herein wherein the wireless temperature sensing device inside a closed fridge is configured for communication with a sensing device located outside a closed fridge; wherein the display device provides an indication of the temperature of the bottle by colour and wherein the sensing device is compatible with use inside a refrigerator, for example one operating from 1.5-10 Celsius.

In another embodiment the invention relates to a device for measuring a temperature of a wine bottle comprising; a wireless temperature sensing device (100, 200, 300) comprising a resilient band (104, 204, 302) and one or more temperature sensors (106, 206, 304) and a wireless transmitter (306); wherein the device is suitable for wireless communication with a display device (102, 202) comprising a display and a wireless receiver; wherein the display device (102, 202) is optionally remote from the wireless temperature sensing device (100, 200, 300); and the display device (102, 202) is preferably configured to indicate the temperature of the wine bottle as measured by the one or more temperature sensors (106, 206, 304).

In another aspect a printed circuit board (PCB) PCB or other electronic circuitry associated with a component used in a fridge, such as the wireless temperature sensing/transmitter device may be wholly or partially coated, for example with a conformal coating which conforms to the surface of the object to be coated. Such a coating can protect against problems associated with low temperature environments such as fridges and conditions where rapid changes of temperature are taking place. These problems include high levels of condensation, even in an environmentally sealed device.

Precision circuitry (including Integrated Circuits) may suffer degraded accuracy if insulating surfaces become contaminated with ionic substances which can become weakly conductive in the presence of moisture. Most organic coatings are readily penetrated by water molecules. A conformal coating preserves the performance of precision electronics primarily by preventing ionizable contaminants such as salts from reaching circuit nodes. Failure to adequately protect e.g. a PCB from an aggressive environment (such as found in a refrigerator) or regular dramatic temperature change, would simply cause a device to fail within an unacceptably short time frame.

In one embodiment the wireless temperature sensing device comprises an LED display and preferably does not have any sort of display other than a single LED or multiple LEDs. A standard LCD or LED display with lens (such as would be normally commercially available) would “fog” with condensation each time it is placed in the refrigerator, the residue from this condensation, such as is left by water droplets when they dry, would quickly obscure the display and eventually render the display unreadable.

According to a second aspect of the invention there is provided a kit of parts comprising a device for measuring the temperature of a wine bottle according a first aspect of the invention.

According to a third aspect there is provided a computer-implemented method for measuring a temperature of a wine bottle, the method comprising: sensing the temperature of the wine bottle using a wireless temperature sensing device; wirelessly transmitting the temperature of the wine bottle to a remote display device; receiving the temperature of the wine bottle at the remote display device; and displaying the temperature of the wine bottle at the remote display device. In one embodiment the wine bottle is located within a fridge.

The method may further comprise selecting one or more predefined temperature ranges, wherein the selection can be made by a user. Additionally, the method may further comprise providing at least one further temperature indicator at the display device to indicate when the measured temperature of the wine bottle is within the predefined temperature range.

Optionally, the one or more predefined temperature ranges may be defined in relation to at least one of; wine type, grape variety, ambient temperature, food type.

The display device (102) may be a dedicated display device. Additionally or alternatively, the display device (202) may be a mobile computing device comprising a display.

The method may further comprise specifying the temperature range or adjusting the predefined temperature range. The display device may comprise one or more controls to enable the user to select the temperature range or to adjust the predefined temperature range.

Optionally, the at least one further indicator may be a text indicator and/or may be a colour of the display. Additionally, the colour of the display may be altered using a plurality of coloured backlights. Optionally, the display may be configured to flash to indicate when the measured temperature of the wine bottle is within the predefined temperature range.

The wireless temperature sensing device and the display device may communicate via Wi-Fi and/or via Bluetooth and/or via radio frequency.

The one or more predefined temperature ranges may be selected from; sparkling white wine, light bodied white wine and rose wine (6-8° C.), dessert wine (7-10° C.), vintage sparkling wine (8-10° C.), medium white wine (9-11° C.), light bodied red wine (10-12° C.), full bodied white wine (10-13° C.), medium bodied red wine (14-16° C.) and full bodied red wine (16-18° C.).

According to a fourth aspect there is provided a system for measuring a temperature of a wine bottle, the system comprising: a wireless temperature sensing device (100, 200, 300) comprising a resilient band (104, 204, 302), one or more temperature sensors (106, 206, 304) and a wireless transmitter (306); a display device (102, 202) comprising a display and a wireless receiver; wherein the display device (102, 202) is separate from and in wireless communication with the wireless temperature sensor; and wherein the display device (102, 202) is arranged to indicate the temperature of the wine bottle as measured by the one or more temperature sensors.

According to a fifth aspect there is provided computer-readable code, optionally stored on a non-transitory memory medium, which when executed by computing apparatus, causes the computing apparatus to perform the method substantially described herein.

In another aspect, the device may comprise components for accurate temperature detection when a bottle is located in a refrigerator.

By way of background, factors that are relevant when detecting and measuring temperature change of wine are;
The actual temperature of the liquid (e.g. as measured in the center of the bottle);
The measurement of temperature of the bottle exterior and how that compares to the temperature of the wine;
The effect of a change in the surrounding ambient temperature and its effect on the bottle exterior temperature compared to the wine temperature, and the effect the ambient temperature has on the measuring device itself.

Most products in the current market place use a metal plate that simply touches the surface of the wine bottle (normally only touching with very small surface area given the radius of the bottle compared to the metal plate). This approach relies on the conductive transfer of temperature information from the glass surface across a very poor conductive arrangement; this could be impaired by factors such as surrounding ambient air temperature, uneven surface of the glass bottle, a build-up of condensation (water droplets) on the glass surface and a significantly small surface contact area.

Placing a bottle of wine in the fridge will cause all exposed surfaces to conduct the temperature of the ambient air that surrounds the bottle, and the effect of this is that the wine will start to cool as this energy is conducted through the glass and starts to influence the wine. The opposite is true when the bottle is removed from the fridge and the wine begins to rise in temperature given a higher ambient temperature of a room.

When measuring the wine temperature using the exterior glass surface of the bottle, in one embodiment the sensing device of the invention comprises an insulator which is suitable to insulate an area of the glass. In this way the insulated area reflects more closely the temperature of the internal liquid within the bottle (as the liquid attempts to influence the temperature of the glass in this area) rather than reflecting the effect of the change in ambient temperature on the surrounding air and the effect this has on the exposed glass surface.

In one embodiment the insulating material is Neoprene. This has excellent thermal insulation properties (0.05 w/m-k) , The insulator suitable provides an insulated area of glass, suitably not less than 840 mm2, that is not immediately affected by the surrounding air temperature. The insulator material may be 1-3 mm thick, such as 2 mm thick, and suitably can provide a good surface contact with the bottle and/or accommodates any surface imperfections of the glass.

In one embodiment a different material is provided within the boundary of the insulator; this is suitably a thermally conductive interface pad, for example a pad made of a thermally conductive material such as a silicone interface pad. This material suitably has good thermal conductivity properties (such as approx. at least 3.0 w/m-k). The transposition of temperature from the surface of the bottle is performed in the most efficient manner using this material and this information is passed to a thermistor as described below. This thermally conductive material may be 1-3 mm thick, such as 2 mm thick, and suitably can provide a good surface contact with the bottle and/or accommodates any surface imperfections of the glass.

The heat information collected from the glass surface by the thermal pad is preferably transferred into a thermistor. The thermal conductive interface pad is suitably bonded to a metal substrate material (such as, but not confined to aluminium). A thermistor pick up is suitably located between the thermal pad and the metal substrate. The substrate metal material may retain a proportion of the heat information. The insulator, which provides insulation for the glass surface, also suitably provides insulation for the thermal pad and thermistor, shielding them from the immediate effects of the ambient temperature surrounding the bottle.

This arrangement provides the most accurate reading of wine temperature based on glass surface measurement compared to products without the insulator. Products that do not use such insulation are affected adversely by a sudden change in ambient temperature that may cause an inaccurate wine temperature reading, rendering any device without insulation inadequate for the purpose of wine temperature measurement where serving temperature exist within small specific tolerances (often 2 c)

Therefore, the device of the present invention suitably comprises a wireless temperature sensing device comprising a portion configured to contact a bottle which comprises an insulator material and a thermally conductive interface, such as a pad, suitably located within a region of the insulator, the thermally conductive interface also configured to contact the bottle. The conductive interface is configured to transmit temperature information about the bottle temperature in the region where the bottle is insulated from surrounding air. In essence the sensing device is suitable for detecting the temperature of a region of a bottle at an area of the bottle insulated from air.

We have observed that arrangement provides a nominal differential between the measured temperature, and the actual temperature of the wine of no more than 2 degrees within the first 5 minutes, and then nominally may have a differential of around 0.5 to 1 degrees after that time. Other products in the market can be inaccurate by as much as 5 degrees during the same period.

The accuracy of temperature measurement is paramount when cooling wines, especially with varieties such as Chardonnay or Chablis. These wines ideally should be served at 12 degrees Celsius. This is both considerably cooler than ambient room temperatures (circa 21 degrees Celsius), and significantly warmer than most fridges (circa 5 degrees). The ability to accurately track the temperature change when placing this wine in the fridge, or conversely when taking it out of the fridge if it has been over cooled, is key to achieving the best drinking result from this wine. This in one aspect the device is configured for temperature ranges warmer than fridge temperature and lower than ambient room temperature at circa 21 degrees Celsius.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Many of the attendant features will be more readily appreciated as the same becomes better understood by reference to the following detailed description considered in connection with the accompanying drawings.

The preferred features may be combined as appropriate, as would be apparent to a skilled person, and may be combined with any of the aspects of the examples described herein.

### DESCRIPTION OF DRAWINGS

The present description will be better understood from the following detailed description read in light of the accompanying drawings, wherein:

FIG. 1 is an example schematic diagram of a wireless wine thermometer according to a first embodiment;

FIG. 2 is an example schematic diagram of a wireless wine thermometer according to a second embodiment;

FIG. 3 is an example schematic diagram of a wireless temperature sensing device;

FIG. 4 is an example schematic diagram of a wireless wine thermometer display;

FIG. 5 is an example schematic diagram of a device which may be used to implement aspects of the claimed invention.

FIG. 6 is an example diagram of a prior art device detection arrangement

FIG. 7 is an example schematic diagram of a wireless temperature sensing device of the invention

FIG. 8 is an graph showing temperatures profiles of different temperature detection arrangements

Like reference numerals are used to designate like parts in the accompanying drawings.

### DETAILED DESCRIPTION

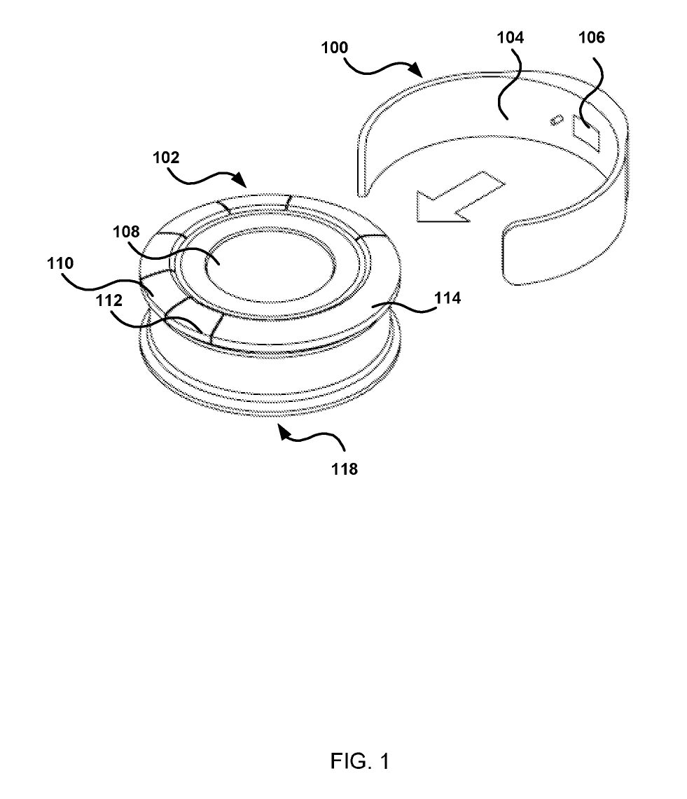

FIG. 1 is an example schematic diagram of a wireless wine thermometer according to a first embodiment. In a first embodiment the wireless wine thermometer may have two components, a wireless temperature sensing device 100 and a display device 102.

The wireless temperature sensing device may comprise a resilient band 104 which may be sized and shaped to fit a standard sized wine bottle. In an example the resilient band 104 may be arranged so that when not in use it is attachable to the display device 102 and when in use it can be removed from the display device 102 and fitted to a wine bottle. The resilient band may be made from stainless steel, plastic or other appropriate resilient material. The wireless temperature sensing device 100 may comprise one or more temperature sensors 106, situated on the resilient band, which are arranged to detect the temperature of the wine bottle when the resilient band is connected to it e.g. the one or more temperature sensors may be arranged to be in contact with a wine bottle when placed around the bottle. The wireless temperature sensing device 100 may be in wireless communication with the display device 102 so that temperature measurements measured by the temperature sensor 106 may be communicated to the display device 102. In an example wireless communication between the display device 102 and the wireless temperature sensing device 100 may be via Wi-Fi, Bluetooth™, radio frequency or other appropriate wireless communication methods. For example, the wireless temperature sensing device may comprise an RF transmitter and the display device may comprise an RF receiver.

The display device may comprise a display 108 which may be an LCD, LED or other appropriate type of screen. In an example the display 108 may be arranged to display the temperature. For example, the display may be used to display the current temperature of a wine bottle to which the wireless temperature sensing device 100 has been connected. In an example, the user may be able to specify a temperature range which is desired for the bottle. For example, the temperature range may be a predefined temperature range dependent on the type of wine; the user may be able to navigate a menu system to select the type of wine and a predefined temperature range associated with the type of wine will automatically be specified. In another example the user may be able to specify one or more additional temperature ranges which may be stored as one or more presets. In a further example the predefined temperature range may be predefined dependant on grape variety, geographical origin, ambient temperature, food type etc. The display device may also comprise one or more buttons or other control switches 110, 112, 114 which may be used to control one or more aspects of the device. In an example the control switches may comprise forward/back switches 110, 112 which may be used to navigate predefined menu functions and/or one or more control switches 114 which may be used to define user preset options by, for example, enabling a user to specify a temperature range or adjust a predefined temperature range.

In an example, the display 108 may display current temperature information which is transmitted from the temperature sensor 106. In other examples the display 108 may additionally display other information, for example; the type of wine selected, the target temperature and a secondary indicator. The secondary indicator may indicate for example, when the wireless temperature sensor 106 detects the temperature of the wine bottle is below the specified temperature range, when the temperature range is above the specified temperature range or within the specified temperature range. The secondary indicator may further indicate when the temperature sensor 106 detects that the wine is at an ideal temperature e.g. in the middle of the specified temperature range. In various examples the display may comprise a further indicator e.g. a backlight (not shown) which indicates via colour whether the measured temperature is within the appropriate range. For example, if the temperature is below the correct range the display may be lit in a different colour than if it is within the correct range, furthermore, if the temperature is above the correct range the display may be lit in a colour which is different again. In another example the display may flash rather than being lit continuously when the wireless temperature sensor detects the temperature of the wine bottle is within the correct temperature range. A flashing display draws a user's attention and also enables battery life to be conserved.

In various examples the display device may further comprise a magnet 118 (not shown), e.g. a magnet on the rear of the device, to enable it to be attached to a metallic surface, for example, a fridge door. The display device 102 may further comprise one or more batteries. In various examples the display device may be arranged to turn off automatically after a period of time in which data is not received from the temperature sensor 106.

In an example a user may place the resilient band 104 around a bottle of wine which is placed in a first location e.g. a fridge, a wine-rack or a wine cellar. The user can then place the display device in a different location somewhere that is easily visible, for example if a user is in the kitchen they may attach the display device 102 to the outside of the fridge or to a the kitchen counter. Alternatively the user may take the display device 102 with them, for example the user may take the display device with them to a dining table. The user is then able to see at a glance whether the wine bottle to which the resilient band 104 has been attached and therefore the wine within the bottle, is at a correct temperature for drinking without having to check the bottle itself by, for example, opening the refrigerator or having to open the bottle in advance to place a thermometer within the bottle of wine, or having to continuously open the fridge to monitor the wine bottle temperature which in turn will raise the ambient temp of the fridge and extend the chilling time.

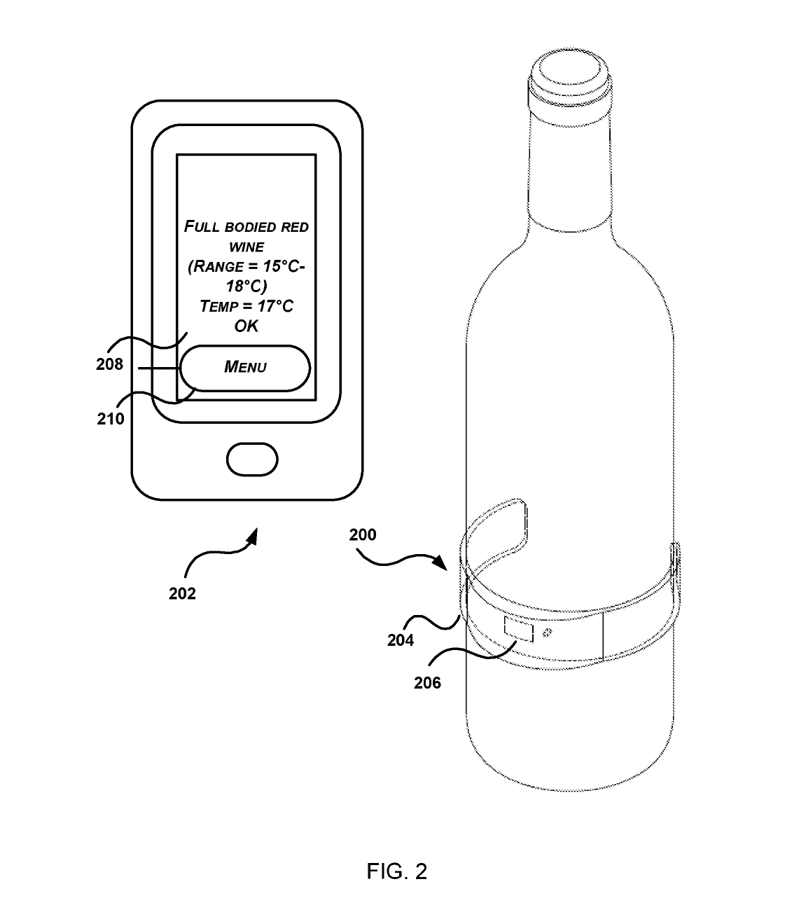

FIG. 2 is an example schematic diagram of a wireless wine thermometer according to a second embodiment. In a second embodiment a wireless wine thermometer comprises a wireless temperature sensing device 200 comprising a resilient band 204 which may be sized and shaped to fit a standard sized wine bottle. The resilient band 204 may comprise one or more temperature sensors 206 which are arranged to detect the temperature of the wine bottle when the resilient band is connected to it (i.e. as shown in FIG. 2, the temperature sensor 206 may contact the bottle). The wireless temperature sensing device 200 may be arranged to communicate wirelessly with a display device 202, e.g. to communicate temperature data. In an example, the display device 202 may be a mobile telephone, tablet PC or other portable computing device arranged to run an application 208 for display the temperature of a wine bottle to which the wireless temperature sensing device has been attached. In an example wireless communication between the display device 202 and the wireless temperature sensing device 200 may be via Wi-Fi, Bluetooth™, radio frequency or other appropriate wireless communication methods. For example, the wireless temperature sensing device may comprise an RF transmitter and the display device may comprise an RF receiver.

In an example the application 208 may display current temperature information which is transmitted from the temperature sensor 206. For example, the application may be able to display the current temperature of a wine bottle on which the temperature sensor 206 has been placed. In an example, the user may be able to specify a temperature range which is desired for the bottle. For example, the temperature range may be a predefined temperature range dependent on the type of wine. The user may be able to navigate a menu system to select the type of wine and set the required temperature range. In another example the user may be able to specify one or more additional temperature ranges which may be stored as one or more presets. In an example the application 208 may comprise one or more interactive features 210 which enable a user to navigate menus to select a predefined temperature range for a specific type of wine or to enable a user to specify a temperature range or adjust a predefined temperature range. In an example, the interactive features 210 may be touch screen features e.g. touch screen menu buttons.

In other examples the application 208 may additionally display other information, for example; the type of wine selected, the target temperature and a secondary indicator. The secondary indicator may indicate, for example, when the temperature monitor senses the temperature of the wine bottle is below the specified temperature range, when the temperature range is above the specified temperature range or within the specified temperature range. The secondary indicator may further indicate when the temperature sensor 206 detects that the wine is at an ideal temperature e.g. in the middle of the specified temperature range. In various examples the display may comprise a further indicator e.g. the colour of the display may change to indicate via colour whether the measured temperature is within the appropriate range. For example, if the temperature is below the correct range the display may be lit in a different colour than if it is within the correct range furthermore if the temperature is above the correct range the display may be lit in a colour which is different again. In various examples the display may comprise a further indicator which indicates via colour whether the measured temperature is within the appropriate range. For example, if the temperature is below the correct range the display may be a different colour than if it is within the correct range furthermore if the temperature is above the correct range the display may be a colour which is different again. In another example the display may flash rather than being lit continuously when the wireless temperature sensor detects the temperature of the wine bottle is within the correct temperature range.

In the embodiments described above, the one or more predefined temperature ranges may be predefined temperature ranges dependent on the type of wine, for example, sparkling white wine, light bodied white wine and rose wine (6-8° C.), dessert wine (7-10° C.), vintage sparkling wine (8-10° C.), medium white wine (9-11° C.), light bodied red wine (10-12° C.), full bodied white wine (10-13° C.), medium bodied red wine (14-16° C.) and full bodied red wine (16-18° C.).

In another example the user may be able to adjust the predefined ranges or specify their own preferred preset ranges based on a plurality of factors, for example, ambient temperature, food type, personal preference, seasonality or grape variety. The specified temperature ranges are provided by way of example only. In other examples the specified temperature ranges may differ from those stated. For example, predefined temperature ranges may differ by +/−2° C. from those specified above.

In the embodiments described above, the wireless wine thermometer may comprise additional functionality. For example, the wireless wine thermometer may incorporate a camera or other device which enables the wine thermometer to read barcodes, e.g. QR codes found on bottles. In an example data from a barcode may be used to access information relating to a wine, for example, appropriate serving temperature range, food matches etc. which in an example may be displayed at display 108 or application 208. Where the appropriate temperature range can be accessed, this may be used to set the predefined range of the wireless wine thermometer to the appropriate temperature range.

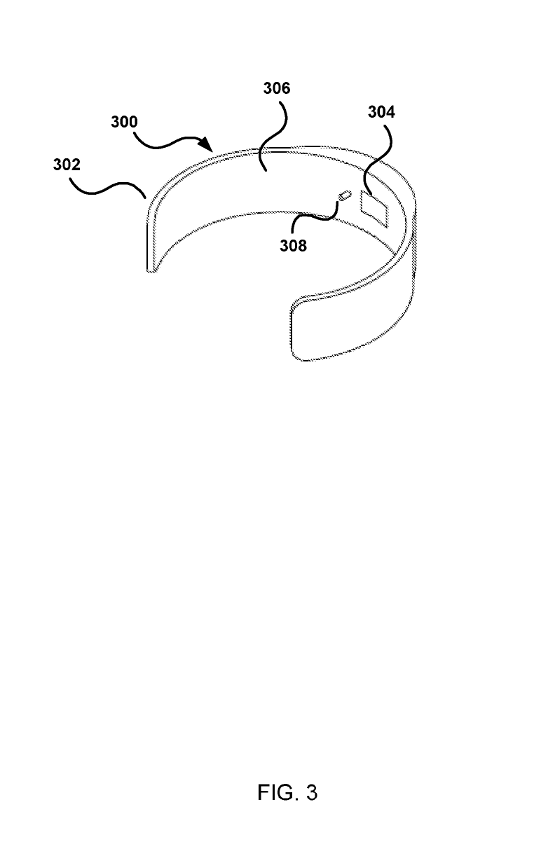

FIG. 3 is an example schematic diagram of a wireless temperature sensing device. In an example a wireless temperature sensing device 300 comprising a resilient band 302, as described above, which is sized and shaped to fit around a wine bottle, for example, the resilient band 302 may be sized and shaped so that it can be readily fitted to the centre of a standard sized wine bottle however the resilient band may have enough flexibility to fit around bottles of various sizes. The resilient band may comprise one or more temperature sensors 304 which may be any appropriate type of temperature sensor, for example, a thermistor e.g. plastic film flexible thermistor, resistance temperature sensor, thermocouple, silicon band gap sensor or other appropriate type of sensor. The wireless temperature sensing device may comprise a transmitter 306 (not shown) which is arranged to transmit data from the one or more temperature sensors 304 to the display device 102, 202. In an example, the resilient band may further comprise one or more batteries, the one or more batteries arranged to provide power to the wireless transmitter 306 and/or the temperature sensor 304. In an example the wireless transmitter is an RF transmitter.

In various embodiments the wireless temperature sensing device may further comprise a switch 308 which enables the device to be powered on and off to conserve battery life. In an example the switch may be a micro-switch. In various embodiments the switch may be arranged so that it is in an open position until it is depressed. For example, when the resilient band 300 is connected to a wine bottle by placing the band around a bottle such that a close fit is achieved, the close fit of the band to the bottle may cause the switch to be depressed closing the switch and enabling power to be supplied to the wireless transmitter 306 and/or the temperature sensor. In an example the wireless temperature sensing device may comprise one or more indicators 310 arranged to indicate whether the device has turned on correctly. In an example the indicator may be an LED indicator. The LED indicator may be arranged to flash several times when the switch 308 is depressed.

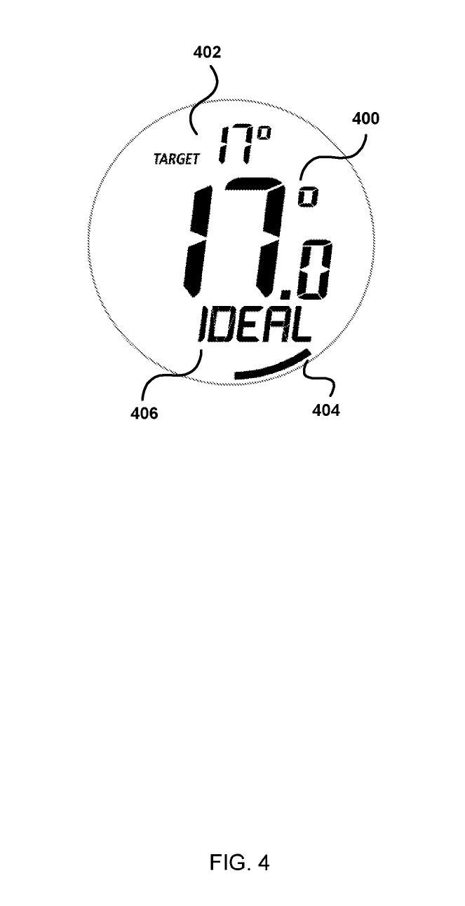

FIG. 4 is an example schematic diagram of a wireless wine thermometer display. In the examples shown herein the display device is a dedicated display device, however the display may alternatively be implemented within a general purpose device e.g. a mobile phone, tablet or other computing device.

In the described example the wireless wine thermometer has been set to the “full bodied red” predefined temperature range which indicates when a bottle of full bodied red wine is at an acceptable serving temperature—herein taken to be 16-18° C. However, the skilled person will understand that a wireless wine thermometer may be set to any predefined temperature range as described herein or other preset range specified by the user. In an embodiment the display device has a primary indicator 400 which displays the currently measured temperature of a bottle of wine to which the wireless temperature sensing device has been attached and a secondary indicator 402 indicating the target (ideal) temperature. The display device may further comprise an additional indicator for the selected wine type 404 and a text indicator 406. In various examples the text indicator 406 may indicate whether the current temperature is under the selected predefined temperature range, within the selected predefined temperature range, at a target temperature e.g. in the middle of the selected predefined temperature range (“ideal” temperature, as shown in FIG. 4), or above the selected predefined temperature range. In various examples the text indicator 406 may use simple text to indicate the temperature of the wine bottle to which the wireless temperature sensing device has been attached e.g. “under”, “over”, “OK”, “ideal” etc, or equivalent wording in other languages

In various examples the wireless wine thermometer display may use a plurality of display colours (not shown) to indicate to the user at a glance whether the wine bottle to which the wireless temperature sensing device has been attached is at an appropriate serving temperature. For example, if the measured temperature is below the desired temperature range then the display may be arranged to turn blue, if the measured temperature is within the desired temperature range then the display may be arranged to turn green and if the measured temperature is above the desired temperature range then the display may be arranged to turn red. In various embodiments the display colour may be changed using e.g. different backlight colours or changing the colour of the screen. In an alternative example an audio alert may be used to alert the user to the fact that the measured temperature is within the desired range. As noted above, in another example, the display may flash rather than being lit continuously when the wireless temperature sensor detects the temperature of the wine bottle is within the desired temperature range. A flashing display draws a user's attention and also enables battery life to be conserved.

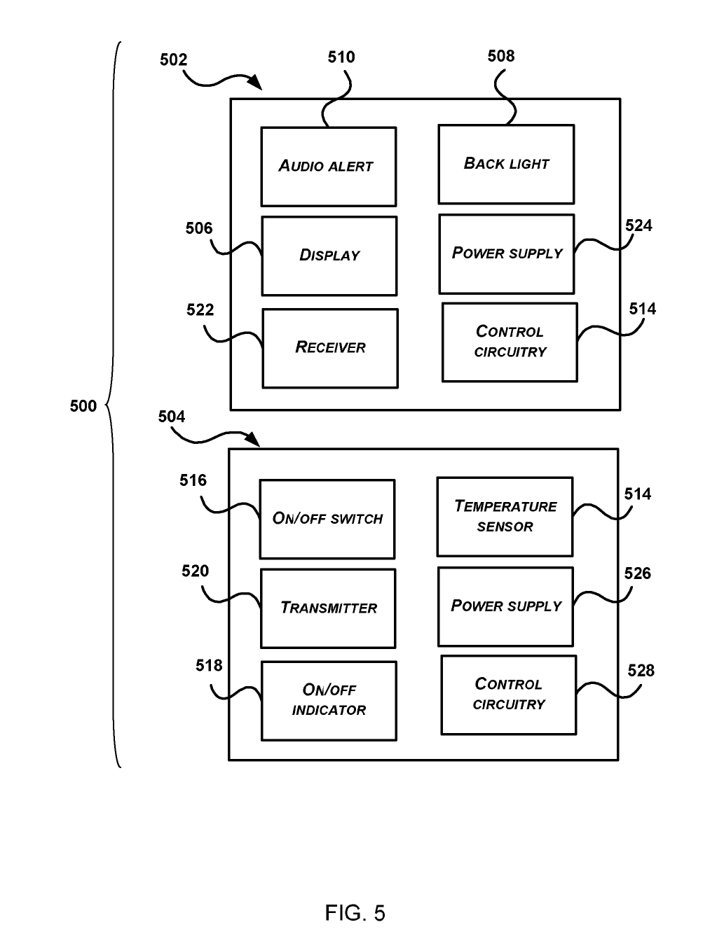

FIG. 5 is a schematic diagram of an example wireless wine thermometer. The wireless wine thermometer 500, as described above, may be comprised of a display device 502 and a wireless temperature sensing device 504.

In an example the display device 502 may comprise a display 506 which be a Liquid Crystal Display. Liquid Crystal Displays are low cost, low energy and relatively robust therefore very suitable for this type of application. However, any other type of suitable display may be used. The display may be backlit it using a back light 508 which may be located at the side or at the rear of the display. The device may comprise an audio alert 510. The display device may further comprise a receiver 522 arranged to receive temperature information from the wireless temperature sensing device 504 and control circuitry 514 arranged to control the display in response to user inputs and received temperature information.

In one embodiment the wireless temperature sensor device may have a single multiple colour LED or multiple LEDs that reflect any colour backlight indication on the wireless display device.

The wireless temperature sensing device 504 may comprise a temperature sensor 516 as described above and a transmitter 520 arranged to transmit temperature information from the temperature sensor to the display device 502. As described above wireless temperature sensing device may further comprise an on/off switch 518 and an on/off indicator 520. The wireless temperature sensing device may further comprise control circuitry 528 arranged to control one or more of the temperature sensor 516 and transmitter 520.

The display device 502 and wireless temperature sensing device 504 may both comprise a power supply 524, 526 which is arranged to provide power. In an example an appropriate power supply is a battery.

In an example the temperature monitoring device may be provided as a kit of parts comprising any of; a display device and a wireless temperature sensing device.

The embodiments described herein with reference to FIGS. 1-5 refer to example configurations and are not intended to be limiting.

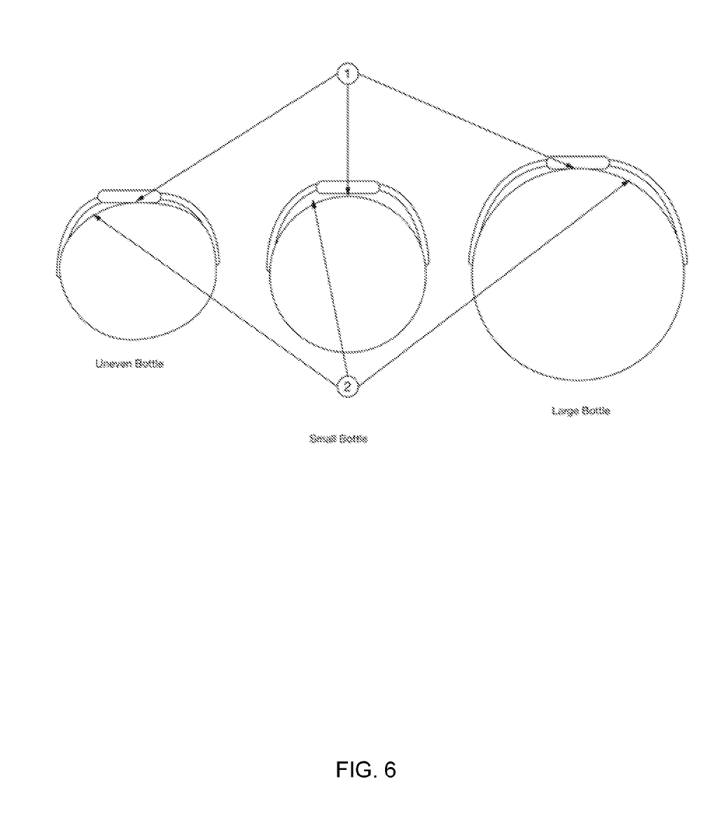

A further aspect of the invention is explained by reference to in FIGS. 6-8 (again, not intended to be limiting). Most products in the current market place use a metal plate that simply touches the surface of the wine bottle (normally only touching with very small surface area given the radius of the bottle compared to the metal plate) (see FIG. 6). This approach relies on the conductive transfer of temperature information from the glass surface across a very poor conductive arrangement (see FIG. 6 contact point 1); this could be impaired by factors such as surrounding ambient air temperature (which also affects the surfaces of the thermometer and any natural air gaps created by the products shape or mounting) (see FIG. 6 point 2), an uneven surface of the glass bottle, a build up of condensation (water droplets) on the glass surface and a significantly small surface contact area.

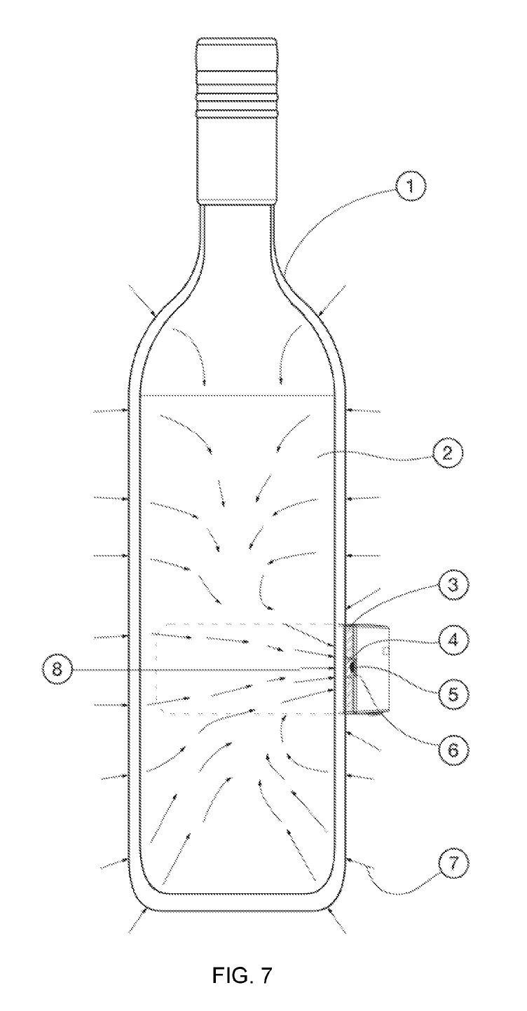

The effect of placing a bottle of wine in the fridge (see FIG. 7) will cause all exposed surfaces to conduct the temperature of the ambient air that surrounds the bottle (7), and the effect of this is that the wine will start to cool as this energy is conducted through the glass and starts to influence the wine (2). The opposite is true when the bottle is removed from the fridge and the wine begins to rise in temperature given a higher ambient temperature of a room.

When attempting to measure the wine temperature using the exterior glass surface of the bottle, the present invention insulates a particular area of glass (3) such that it represents more closely the temperature of the internal liquid (as the liquid attempts to influence the temperature of the glass in this area) (8) rather than being significantly affected by the effect of the change in ambient temperature on the exposed glass surface (7).

Our design has been modified in 4 ways compared to other products available in the market:
1. We use an insulating material; Neoprene is a preferred material. This has excellent thermal insulation properties (0.05 w/m-k) to create an insulated area of glass (3) (not less than 840 mm²) that is not being immediately affected by the surrounding air temperature. This malleable material is nominally 2 mm thick, which provides a good surface contact with the bottle and accommodates any surface imperfections and curvatures of the glass.
2. We provide a differential material in the center of the neoprene insulation; this is a thermally conductive silicone interface pad (4). This material has good thermal conductivity properties (approx. 3.0 w/m-k). The transposition of temperature from the surface of the bottle is performed in a very efficient manner using this material and this information is passed to a thermistor (5) as described below in point 3. This malleable material is nominally 2 mm thick, which provides a good surface contact with the bottle and accommodates any surface imperfections and curvatures of the glass.
3. The thermal conductive interface pad (4) is bonded to a metal substrate material (such as, but not confined to aluminium) (6). A thermistor pick (5) up is sandwiched between the thermal pad and the metal substrate. The heat information collected from the glass surface by the thermal pad (4) is transferred into the thermistor (5), and the substrate metal material (6) retains a proportion of this heat information. The Neoprene insulator (3), which provides insulation for the glass surface, also provides significant insulation for the thermal pad and thermistor shielding them from the immediate effects of the ambient temperature (7) surrounding the bottle (1).
4. The internal printed circuit board (PCB) has been treated with a conformal coating to provide protection against moisture and to withstand extreme temperature variations.

During testing we have found this method of constriction compared to other market products, which do not use this insulation/transfer method, provides the most accurate reading of wine temperature based on glass surface measurement. It can also be demonstrated that products that do not use such insulation are affected adversely by a sudden change in ambient temperature that may cause an inaccurate wine temperature readings over a period of time, rendering any device without insulation inadequate for the purpose of wine temperature measurement where serving temperature exist within small specific tolerances (often 2 c)

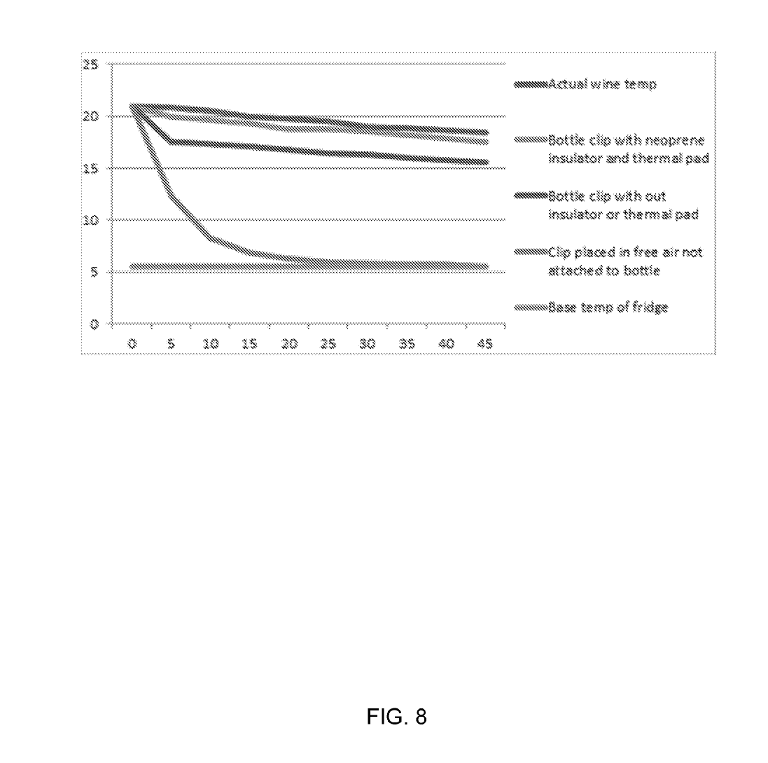

FIG. 8 which shows details of time on the x axis [in minutes] vs temperature on the Y axis in degrees Celsius. The lines on the graph are in the same order, top to bottom, as the key—with actual wine temperature the top line and fridge temperature the bottom line for example.

This arrangement provides a nominal differential between the measured temperature and the actual temperature of the wine of no more than 2 degrees within the first 5 minutes, and then nominally may have a differential of around 0.5 to 1 degrees after that time. The market competitors can be inaccurate by as much as 5 degrees during the same period.

The accuracy of temperature measurement is paramount when cooling wines, especially with varieties such as Chardonnay or Chablis. These wines ideally should be served at 12 degrees Celsius. This is both considerably cooler than ambient room temperatures (circa 21 degrees), and significantly warmer than most fridges (circa 5 degrees). The ability to accurately track the temperature change when placing this wine in the fridge, or conversely when taking it out of the fridge if it has been over cooled, is key to achieving the best drinking result from this wine.

Any range or device value given herein may be extended or altered without losing the effect sought as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

As will be appreciated, the temperature ranges given, are examples only and the ranges could be different or smaller.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

It will be understood that the benefits and advantages described above may relate to one embodiment or may relate to several embodiments. The embodiments are not limited to those that solve any or all of the stated problems or those that have any or all of the stated benefits and advantages.

The systems and apparatus described above may be implemented at least in part in computer software. Those skilled in the art will appreciate that the apparatus described above may be implemented using general purpose computer equipment or using bespoke equipment. The different components of the systems may be provided by software modules executing on a computer.

The hardware elements, operating systems and programming languages of such computers are conventional in nature, and it is presumed that those skilled in the art are adequately familiar therewith. In an embodiment the server may be centrally located and the clients are distributed. In other embodiments, the server functions may be implemented in a distributed fashion on a number of similar platforms, to distribute the processing load.

Here, aspects of the methods and apparatuses described herein can be executed on a computing device such as a server. Program aspects of the technology can be thought of as “products” or “articles of manufacture” typically in the form of executable code and/or associated data that is carried on or embodied in a type of machine readable medium. “Storage” type media include any or all of the memory of the computers, processors or the like, or associated modules thereof, such as various semiconductor memories, tape drives, disk drives, and the like, which may provide storage at any time for the software programming. All or portions of the software may at times be communicated through the internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

Hence, a machine readable medium may take many forms, including but not limited to, a tangible storage carrier, a carrier wave medium or physical transaction medium. Non-volatile storage media include, for example, optical or magnetic disks, such as any of the storage devices in computer(s) or the like, such as may be used to implement the encoder, the decoder, etc. shown in the drawings. Volatile storage media include dynamic memory, such as the main memory of a computer platform. Tangible transmission media include coaxial cables; copper wire and fiber optics, including the wires that comprise the bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will appreciate that while the foregoing has described what are considered to be the best mode and, where appropriate, other modes of performing the invention, the invention should not be limited to specific apparatus configurations or method steps disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognize that the invention has a broad range of applications, and that the embodiments may take a wide range of modifications without departing from the inventive concept as defined in the appended claims.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1. A device for measuring a temperature of a wine bottle comprising;
a wireless temperature sensing device (100, 200, 300) comprising a resilient band (104, 204, 302) and one or more temperature sensors (106, 206, 304) and a wireless transmitter (306);
wherein the wireless temperature sensing device is connectable with a display device, the display device (102, 202) comprising a display and a wireless receiver; wherein the display device (102, 202) is separate from and may be in wireless communication with the wireless temperature sensor; and the display device (102, 202) is arranged to indicate the temperature of the wine bottle as measured by the one or more temperature sensors.

2. A device for measuring a temperature of a wine bottle according to claim 1 additionally comprising;
a display device, the display device (102, 202) comprising a display and a wireless receiver; wherein
the display device (102, 202) is separate from and may be in, or is in, wireless communication with the wireless temperature sensor; and
the display device (102, 202) is arranged to indicate the temperature of the wine bottle as measured by the one or more temperature sensors.

3. A device according to claim 1 or 2 further comprising one or more predefined temperature ranges which are selectable by a user.

4. A device according to claim 3 wherein the display device (102, 202) is arranged to provide at least one further temperature indicator arranged to indicate when the measured temperature of the wine bottle is within the predefined temperature range.

5. A device according to claim 3 or claim 4 wherein the one or more predefined temperature ranges are defined in relation to at least one of; wine type, grape variety, ambient temperature, food type.

6. A device according to any preceding claim wherein the resilient band (104, 204, 302) is sized and shaped to connect to a wine bottle.

7. A device according to any preceding claim wherein the display device (102) is a dedicated display device.

8. A device according to any of claims 1-6 wherein the display device (202) is a mobile computing device, such as a mobile telephone.

9. A device according to any preceding claim further arranged to enable the user to manually specify a temperature range or to adjust a predefined temperature range.

10. A device according to any preceding claim wherein the display device (102) comprises one or more controls to enable the user to select a temperature range or to adjust a predefined temperature range.

11. A device according to any of claims 4-10 wherein the at least one further indicator is a text indicator.

12. A device according to any of claims 4-11 wherein the at least one further indicator is a colour of the display.

13. A device according to claim 12 wherein the colour of the display is altered using a plurality of coloured back-lights.

14. A device according to any of claims 4-13 wherein the display is arranged to flash to indicate when the measured temperature of the wine bottle is within the predefined temperature range.

15. A device according to any preceding claim wherein the wireless temperature sensing device and the display device communicate via Wi-Fi.

16. A device according to any of claims 1-14 wherein the wireless temperature sensing device and the display device communicate via Bluetooth.

17. A device according to any of claims 1-14 wherein the wireless temperature sending device and the display device communicate via radio frequency.

18. A device according to any preceding claim wherein the resilient band (104, 204, 302) further comprises a switch arranged to switch the wireless temperature sensing device on when connected to a wine bottle.

19. A device according to any of claims 3-18 wherein the one or more predefined temperature ranges are selected from; sparkling white wine, light bodied white wine and rose wine (6-8° C.), dessert wine (7-10° C.), vintage sparkling wine (8-10° C.), medium white wine (9-11° C.), light bodied red wine (10-12° C.), full bodied white wine (10-13° C.), medium bodied red wine (14-16° C.) and full bodied red wine (16-18° C.).

20. A device according to any preceding claim further comprising a barcode reader.

21. A kit of parts comprising a device for measuring the temperature of a wine bottle according to any of claims 1-20, optionally comprising user information relating to operation of an app or other computer program compatible with, or enabling for, the device, such as user information or an access code for the app or program.

22. A device according to any preceding claim the wireless temperature sensing device comprises an insulator configured to contact a bottle and a thermally conductive interface, such as a pad, suitably located within a region of the insulator, also configured to contact the bottle.

23. A computer-implemented method for measuring a temperature of a wine bottle, the method comprising:
sensing the temperature of the wine bottle using a wireless temperature sensing device, preferably wherein the wine bottle is in a fridge;
wirelessly transmitting the temperature of the wine bottle to a remote display device;
receiving the temperature of the wine bottle at the remote display device; and
displaying the temperature of the wine bottle at the remote display device.

24. A computer-implemented method of claim 23 further comprising selecting one or more predefined temperature ranges.

25. A computer-implemented method of claim 24 further comprising providing at least one further temperature indicator at the display device to indicate when the measured temperature of the wine bottle is within the predefined temperature range.

26. A computer-implemented method of claim 24 or claim 25 wherein the one or more predefined temperature ranges are defined in relation to at least one of; wine type, grape variety, ambient temperature, food type.

27. A computer-implemented method of any of claims 23 to 26 wherein the display device (102) is a dedicated display device.

28. A computer-implemented method of any of claims 23 to 26 wherein the display device (202) is a mobile computing device comprising a display.

29. A computer-implemented method of any of claims 24 to 26 further comprising specifying the temperature range or adjusting the predefined temperature range.

30. A computer-implemented method of claim to 29 wherein the display device (102) comprises one or more controls to enable the user to select the temperature range or to adjust the predefined temperature range.

31. A computer-implemented method of claim 25 wherein the at least one further indicator is a text indicator.

32. A computer-implemented method of claim 25 wherein the at least one further indicator is a colour of the display.

33. A computer-implemented method of claim 32 wherein the colour of the display is altered using a plurality of coloured back-lights.

34. A computer-implemented method of any of claims 23 to 33 wherein the display is arranged to flash to indicate when the measured temperature of the wine bottle is within the predefined temperature range.

35. A computer-implemented method of any of claims 23 to 33 wherein the wireless temperature sensing device and the display device communicate via Wi-Fi.

36. A computer-implemented method of any of claims 23 to 33 wherein the wireless temperature sensing device and the display device communicate via Bluetooth.

37. A computer-implemented method of any of claims 23 to 33 wherein the wireless temperature sending device and the display device communicate via radio frequency.

38. A computer-implemented method of any of claims 23 to 34 wherein the one or more predefined temperature ranges are selected from; sparkling white wine, light bodied white wine and rose wine (6-8° C.), dessert wine (7-10° C.), vintage sparkling wine (8-10° C.), medium white wine (9-11° C.), light bodied red wine (10-12° C.), full bodied white wine (10-13° C.), medium bodied red wine (14-16° C.) and full bodied red wine (16-18° C.).

39. A system for measuring a temperature of a wine bottle, the system comprising:
a wireless temperature sensing device (100, 200, 300) comprising a resilient band (104, 204, 302), one or more temperature sensors (106, 206, 304) and a wireless transmitter (306);
a display device (102, 202) comprising a display and a wireless receiver;
wherein the display device (102, 202) is separate from and in wireless communication with the wireless temperature sensor; and
wherein the display device (102, 202) is arranged to indicate the temperature of the wine bottle as measured by the one or more temperature sensors.

40. Computer-readable code, optionally stored on a non-transitory memory medium, which when executed by computing apparatus, causes the computing apparatus to perform the method of any of claims 23 to 38.
